(19) United States
(12) Patent Application Publication
(10) Pub. No.: US 2008/0286715 A1
(43) Pub. Date: Nov. 20, 2008

(54) SYSTEM AND METHOD FOR PROVIDING AN IMAGE GUIDED IMPLANT SURGICAL GUIDE

(76) Inventor: Woncheol Choi, San Jose, CA (US)

Correspondence Address: Woncheol Choi, 745 DAILEY AVE, SAN JOSE, CA, 95123, US

(21) Appl. No.: 11/749,528

(22) Filed: May 16, 2007

(51) Int. Cl. A61C 9/00

(52) U.S. Cl. 433/37; 901/44

(57) ABSTRACT

An impression tray includes a tray holder; a U-shaped body coupled to the tray holder; and a plurality of indicators positioned on the tray holder and the U-shaped body. The impression tray allows the scanning process to be simplified as the indicators are used for registering the scanned model to patient anatomy. Doctors can examine the scan of the patient first and then make decision for surgical guide. The fabrication system setup is relatively simple. There is no specialized orientation jig. Regardless of the position of the stone model, the coordinates of the drill can be easily calculated.

### BACKGROUND

Advances in 3D medical imaging such as computed tomography or cone beam CT have enabled precise dental implant planning to be possible. The use of CT scans is increasing in dentistry for many reasons, one of which is the ability to visualize the true three-dimensional anatomy of the patient for enhanced diagnosis and treatment planning. Another reason is that a dentist can acquire multiple traditional radiographs from one scan, which could eventually make panoramic and cephalometric machines obsolete. Software such as InVivoDental™ and AnatoModel™, available from the assignee of the instant application, enhances this comprehensive nature of a CT scan by allowing an orthodontist to not only acquire all the radiographs they need, but also virtual study models that includes teeth, roots and alveolar bone; all from one CT scan. For dental implant surgery, CT scanning provides more than diagnostic values. CT images contain precise three-dimensional anatomy and doctor can perform a plan surgery with real size implant on the image. The planning of dental implants can be transferred to the actual surgery by using a surgical guide. The surgical guide is a custom fit device that fits to patient dentition and has a number of holes guiding the drill. Doctor can place the surgical guide in patient dentition and put the drill to the holes in the surgical guide. Then, the doctor can operate precise drill holes in the bone where implants are going to be placed. Then, the doctor inserts the dental implants to the drilled holes in the bone.

During the initial office visit, impressions of patients' dentitions are taken for a variety of purposes among which are procedures for the manufacture of appliances for bite registrations, crown and bridge constructions, and the like. There generally are five types of impression supporting trays used by a dentist for specific applications. These trays are the posterior, anterior, full arch, quadrant, and sideless posterior. The tray is used simply as a carrier for the impression-forming material and to facilitate the placing and removal of the impression material in and from a patient's mouth.

As noted in U.S. Pat. No. 6,835,065, in use, the tray is filled with a pliable, uncured putty or silicone impression material and seated in a patient's mouth until the material sets or cures. Within a few minutes' time the material will set, but remain pliable and not distort when removed from the patient's mouth. When the tray containing the impression material is removed from the patient's mouth an accurate negative impression of the tooth or teeth is completed. The negative impression is used to form an accurate duplicate of the patient's dentition, following which a dental appliance may be produced on a stone model.

One of the drawbacks of s existing surgical guide is that systems require custom fit guides to be made before the CT scan. Normally doctors need to take CT image to diagnosis patient before moving forward for preparing the surgical guide. Thus, the existing systems require awkard reversed order of diagnosis and surgical preparation and require more preparation and more doctor office visit before the surgery. The increased preparation and unconventional treatment process undermine the values of image guided surgical system to doctors.

### SUMMARY

Systems and methods are disclosed for fabricating and using an impression tray with a tray holder; a U-shaped body having first and second ends; a first positioning indicator placed on the tray holder; and a second positioning indicator placed on the first end.

Implementations of the above systems and methods may include one or more of the following. A third positioning indicator can be placed on the second end. The indicator can be a tube or a ball. The indicator is radiographic. The positions of the indicators are registered to virtual coordinates. A dental computer aided design software can receive the virtual coordinates of the indicators to provide virtual planning of implant placement. A stone model can be formed to fit the impression tray. A surgical guide is then molded over the stone model. The surgical guide comprises one or more openings therein as specified by a virtual implant placement planning to receive the implant during surgery.

In another aspect, systems and methods are disclosed for fabricating and using an impression tray with a tray holder; a U-shaped body having first and second ends; and multiple registration indicators are placed on the impression tray. The impression tray is inserted and stabilized in patient mouse while the patient is undergoing a three dimensional CT scanning. The same impression tray is used for fabricating positive plaster stone model. The physical position of the stone model is defined by the registration of the indicator. The registration is done using 5 degree of freedom robotic arm by finding the coordinates of the indicator. The position of indicator can be found by inserting the end effector of the robotic arm to the indicator of the impression tray while sitting on the stone model. The position, orientation and size of the implant is planned using a three-dimensional imaging software and the planned data is input to the fabrication system. Using coordinate transformation from indicators to the stone model, the physical coordinates of the implants are calculated. Utilizing the same stone model, a surgical guide is fabricated and placed on the stone model. Since the coordinates of implants are already calculated, a computer-controlled drill machine can drill a hole on a surgical guide. Then, the surgical guide is delievered to doctor for surgery.

Among other advantages, the impression tray allows the scanning process to be simplified. Doctors can examine the scan of the patient first and then make decision for surgical guide. The fabrication system setup is relatively simple. There is no specialized orientation jig. Regardless of the position of the stone model, the coordinates of the drill can be easily calculated.

Yet other advantages of the guide system may include one or more of the following. Since the impression tray does not require patient specific morphology, it can be mass produced and ready to use when patient is under-going the CT scanning. Further, the proposed design allows easy preparing thus, reduces doctor and patients efforts. Patient can take CT scan without any preparation visit. Doctors need to only use the pre-fabricated impression tray for the scan. Doctor can obtain diagnostic scan without fabrication of custom fit guide. Then, the diagnostic scan image can be used for the implant planning when patient agree to move forward for implant surgery. Second, the fabrication system setup is easy by incorporating a robotic arm for registration of the coordinate systems. The stone model for fabrication surgical guide can be placed any orientation and the robotic arm is used to find the coordinates of the stone mode. Thus, the fabrication setup is simple and accuracy can be improved. Third, just like other surgical guide system, still accurate implant surgeries can be performed. The system offers an implant planning feature that allows clinicians to perform image-based treatment planning for both restorative implants and orthodontic miniscrews. This feature enables precise implant planning through simultaneous buccal, lingual, vertical, and density visualizations. These features are designed to be both easy-to-use and comprehensive, which allows clinicians to treatment plan with efficiency and thoroughness. This is also a powerful tool to dramatically enhance case presentations, increase the percentage of case acceptance, improve communication with patients and colleagues, and inspire confidence in patients and colleagues.

### BRIEF DESCRIPTION OF THE FIGURES

FIG. 1 and FIG. 2 show top and bottom perspective views of a pre-fabricated stock impression tray.

FIG. 3 shows the deployment of the tray with a patient.

FIG. 4 shows an exemplary scanned image of the patient.

FIG. 5 shows an exemplary stone model formed with the tray.

FIG. 6 shows an exemplary fabrication system.

FIG. 7 shows an exemplary plan for surgically placing a dental implant.

FIG. 8 shows an exemplary surgical guide formed above the stone model.

### DESCRIPTION

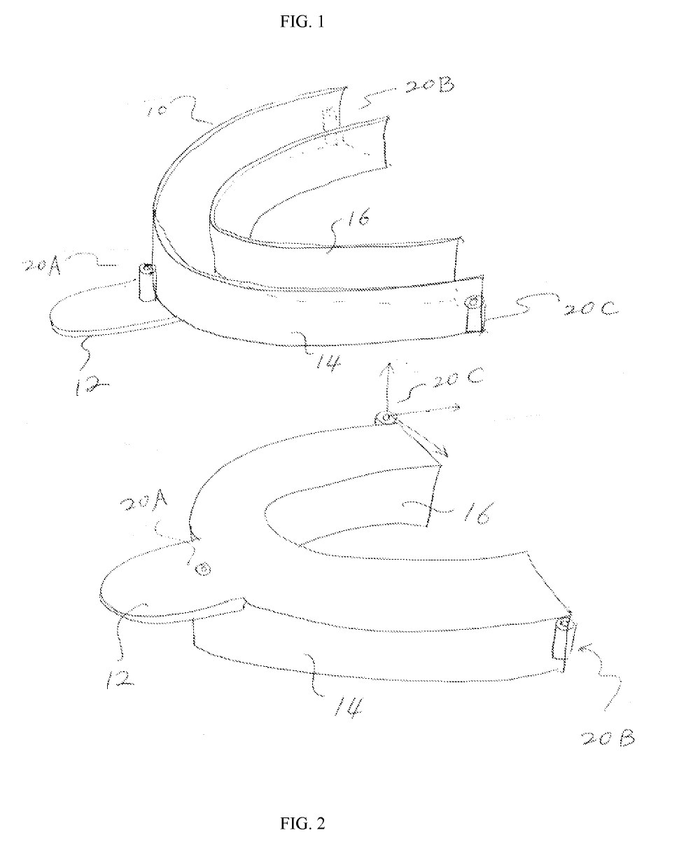

FIG. 1 and FIG. 2 show a pre-fabricated impression tray 10. The impression tray is similar to traditional dental impression tray but it has a plurality of indicators such as metallic tubes 20A-20C attached to the tray. The metallic tube is used for the registration of coordinate systems. This particular embodiment uses three metallic tubes 20A-20C but any number equal or more than 2 tubes can be used. The shape of the metallic registration feature is not limited to tube. One can use any shape as far as it can mate to an end effector of a registration arm.

The tray 10 has a generally U-shaped frame having a pair of spaced apart, generally parallel walls 14 and 16. Multiple size and shapes of tray can be used to accommodate the different size of patient dentition. Near the top of the U shape is a large area handle or grip 12 joined to an outer or buccal wall 14 and an inner wall 16. The area of the grip 12 is sufficient to facilitate the transfer of the tray from one person's hand to another person's hand.

The tray parts thus far described preferably are unitarily molded from an elastomeric material of the kind conventionally used for the making of dental impression trays, such as a moldable glass-filled nylon substance, but any one of a number of readily available materials may be used in the formation of the tray limbs and handle. One suitable impression material adapted for use with the tray is a pliable, putty-like silicone substance which is readily available in the marketplace.

In one embodiment, the components of the tray are molded integrally with a support formed of open mesh netting which spans the walls 14 and 16. The mesh may be composed of any one of a number of suitable plastic gauzes having fairly uniformly spaced openings therethrough. The walls 14-16 are of such height as to extend both above and below the level of the mesh. The construction and arrangement of the impression tray are such that dental impression material (not shown) may be placed in overlying relation on opposite sides of the supporting mesh and in such quantity as to ensure lateral displacement of portions of the material outwardly against the buccal wall 14 when the tray and impression material supported thereby are placed in a patient's mouth and the patient moves his jaw in such manner as to compress the impression material between the upper and lower teeth.

As the patient's teeth enter the impression material supported by the tray the impression material will be displaced both laterally and vertically. Laterally outward displacement will be restrained by the buccal wall 14, thereby avoiding excessive lateral displacement of the impression material. The wall 16 also will restrain to some extent inward displacement of the impression material. Once the dental impression material has become set, it nevertheless is elastically pliable so as to permit removal from the patient's mouth without distortion.

The tubes 20A-20C are placed at predetermined locations on the tray 10. The tubes 20B-20C are flushed with the back side of tray or slightly sticking out from the back side such that the the back side of the tray does not interfere with the mating registration end effector The tray 10 itself should be radio-translucent or significantly different density such that the tube is well visible in X-ray image.

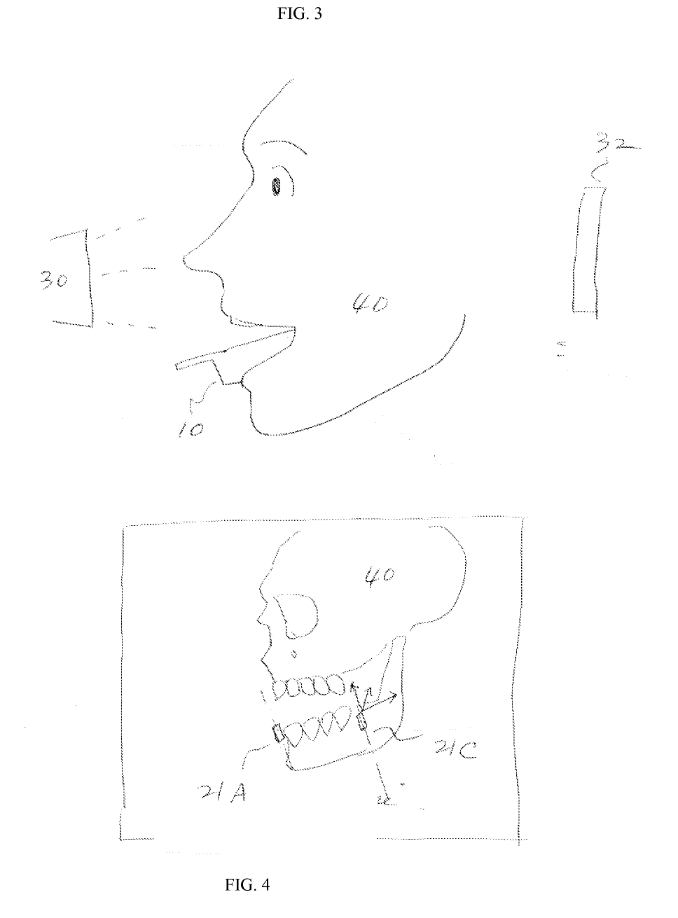

FIG. 3 shows the deployment of the tray 10 with a patient 40. The impression material is poured on the tray and placed in the patient dentition. After the impression material has hardened, the patient undergoes the imaging such as medical CT scan or dental conebeam scan through a source 30 whose radiation is captured by a sensor 32. The impression tray 10 is secured in the patient's mouth to be accurately registering the metallic tubes 20A-20C.

FIG. 4 shows an exemplary scanned image of the patient 40. The image shows the patient 40 anatomy including his or her dentition as well as the images 21A-21C of the metallic tubes 20A-20C. Once the medical CT, conebeam CT, or any other 3D scan is done, an accurate 3D position of metallic tube is registered with the image.

From the image, a coordinate system is established. The first one is the physical coordinate system A on the tray 10 as shown in FIG. 2. The locations of tubes 20A-20C, with two or more tubes, enable a complete 3D coordinate system to be established. The same coordinate system can be represented in the 3D image. As shown in FIG. 4, 3D image shows the metallic tubes and the virtual coordinate system A′ can be established exactly same way as the physical coordinate system A.

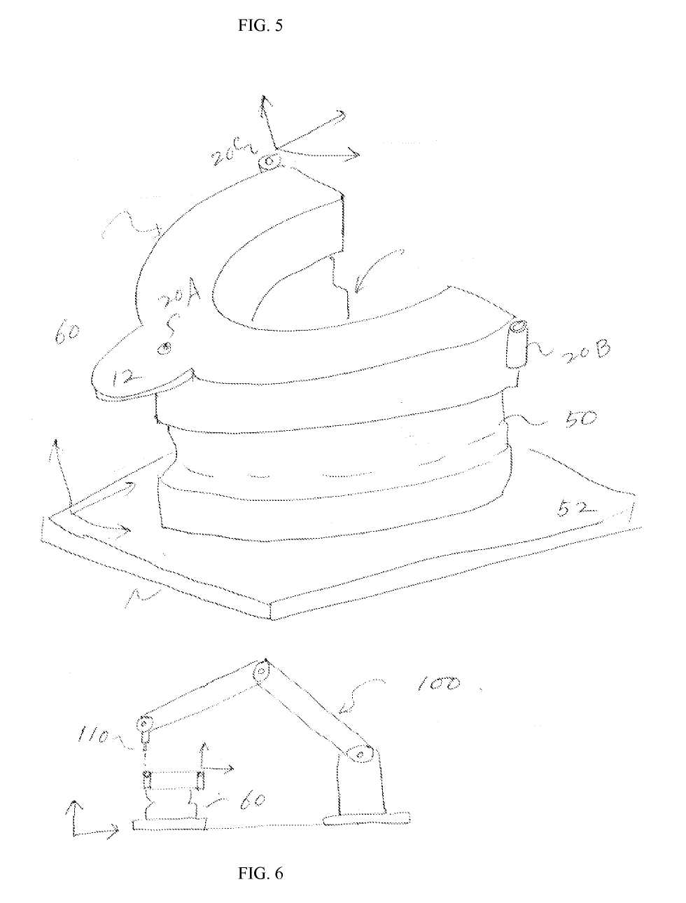

FIG. 5 shows the physical setup with the impression tray. After the impression tray is scanned with patient, the tray is removed from the patient. Then, a traditional plaster stone model is created from the impression tray. Then, the stone model is firmly mounted on the base with a common fixture system. In FIG. 5 the tray 10 is used to form a stone model 50. The stone model 50 rests above a base 52.

FIG. 6 shows the registration robotic arm. The fabrication system includes a robotic arm 100 that has an end effector 110 and a computer controlled drill system (not shown). The end effector is cylindrical peg that has the same diameter as the inner diameter of the tube 20A-C. The drill can be also mounted on the robotic arm 100 as well. The fabrication system is mounted on the system base as shown in FIGS. 5 and 6. A new coordinate system B is defined on the system base 52.

Next, the registration step is detailed. From the impression, a plaster mold can be poured in and the stone model 50 can be fabricated. The stone model 50 is a positive copy of the patient dentition. The stone model 50 is used as mold for creating the surgical guide. The stone model 50 is secured mounted on the system base 52 as shown in FIG. 5 and the impression is attached to the stone model 50. Since the stone model 50 is created from the impression, the impression must fit tightly with the stone model. Next, as shown in FIG. 5, the impression on tray 10 and stone model 50 are both secured and mounted on the system base 50. Thus, the coordinate system A and coordinate system B are statically defined. To calculate the coordinate transformation between A and B, the end effector robotic arm 110 is placed on the metallic tubes 20A-20C. The robotic arm can record the precise coordinates of the end effector 110 location. From the multiple mating locations of end effector and the tubes 20A-20C, the transformation between coordinate A and B can be calculated.

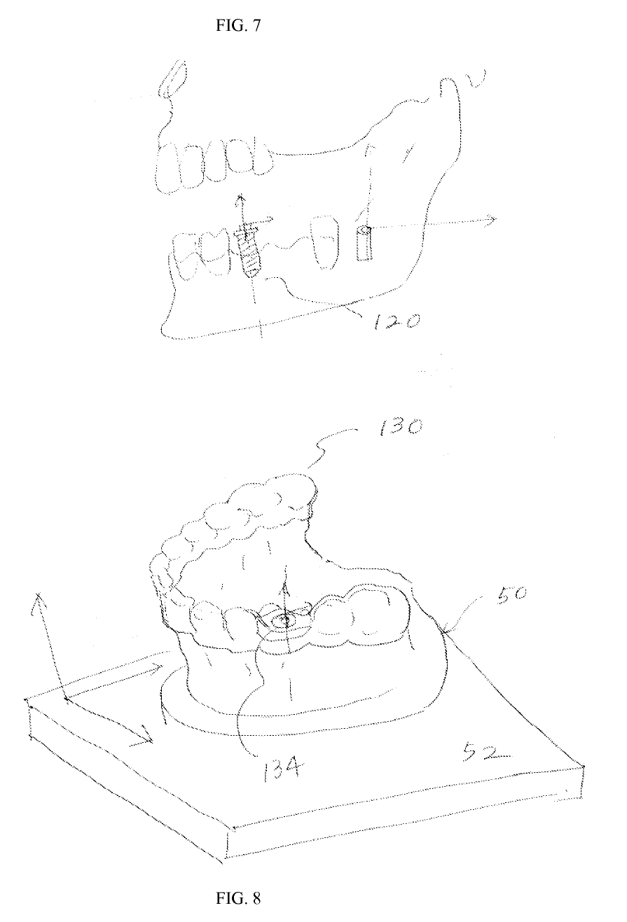

Turning now to the implant planning process, a doctor performs implant surgery planning using the image data, one example of which is shown in FIG. 7. The doctor places one or more virtual implants 120 on the CT image. Doctor can diagnosis three-dimensional morphology of patient bone, nerve and the teeth and make the decision of implant position, orientation and sizes. Then, the software calculates the position of each implant with respect to the virtual coordinate system A′. The planning data is delivered to the lab where the fabrication system is located.

Next, the system fabricates a custom fit guide 130. The custom fit guide material can be fabricated from the stone model 50. From the stone model 50 mounted above the system base 52, a user or a robot removes the impression and places the guide 130. The positions of implants are known from the planning software data, and the coordinate transformation between A and B is calculated from the registration. Thus, the position of implants in coordinate B can be calculated. Then, a computer-controlled drill can drill holes on the guide 130 where the implants should go as shown in FIG. 8. If the surgical guide material is not strong enough to guide the drill of the surgeon, optional metallic tubes can be inserted inside the hole. The metallic tube will have outside diameter same to the drilled hole in the guide and inner diameter same to the drill that surgeon will be using.

Turning now to the deployment of the guide 130 during surgery, the surgical guide 130 is shipped to doctor. The doctor places the surgical guide 130 on the patient dentition. The guide 130 has holes 134 and the doctor then performs surgery by drilling the patient's gum and bone along the holes 134 in the guide 130. Then, the doctor places the implant inside the drilled bone. The position of the implant is highly accurate and is predetermined as the doctor planned on imaging data.

The techniques described here may be implemented in hardware or software, or a combination of the two. Preferably, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices.

Moreover, each program is preferably implemented in a high level procedural or object-oriented programming language to communicate with a computer system. However, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

The above-described embodiments of the present invention are merely meant to be illustrative and not limiting. Various changes and modifications may be made without departing from the invention in its broader aspects. The appended claims encompass such changes and modifications within the spirit and scope of the invention.

What is claimed is:

1. An impression tray, comprising:
a. a tray holder;
b. a U-shaped body coupled to the tray holder; and
c. a plurality of indicators positioned on the tray holder and the U-shaped body.

2. The impression tray of claim 1, wherein the indicator comprises a tube.

3. The impression tray of claim 1, wherein the indicator comprises a predetermined shape to mate to an end effector of a robotic arm.

4. The impression tray of claim 1, wherein the indicator is radio-opaque.

5. The impression tray of claim 1, wherein the patient takes CT scan while wearing the tray

6. The impression tray of claim 1, wherein the indicator is positioned flushed to a back side of the tray or protruding from the back side to mate with an end effector without interference.

7. The impression tray of claim 1, comprising a virtual coordinate system defined by positions of the indicators.

8. The impression tray of claim 7, comprising a dental computer aided design software adapted to receive the virtual coordinates of the indicators to provide virtual planning of implant placement.

9. The impression tray of claim 1, comprising a stone model adapted to be formed using the impression tray.

10. The impression tray of claim 9, comprising a surgical guide adapted to be received by the stone model.

11. The impression tray of claim 10, wherein the surgical guide comprises one or more openings therein as specified by a virtual implant placement planning.

12. A method for forming an impression tray having a tray holder and a U-shaped body having first and second ends, the method comprising:
a. placing a first positioning indicator placed on the tray holder; and
b. placing a second positioning indicator placed on the first end.

13. The method of claim 12, comprising placing a third positioning indicator placed on the second end.

14. The method of claim 12, wherein the indicator comprises a tube.

15. The method of claim 12, wherein the indicator is radio-opaque.

16. The method of claim 12, wherein the positions of the indicators are registered to virtual coordinates.

17. The method of claim 16, comprising using a dental computer aided design software to receive the virtual coordinates of the indicators to provide virtual planning of implant placement.

18. The method of claim 11, comprising forming a stone model adapted to be formed using the impression tray.

19. The method of claim 18, comprising forming a surgical guide adapted to be received by the stone model.

20. The method of claim 19, wherein the surgical guide comprises one or more openings therein as specified by a virtual implant placement planning.

21. The method of claim 11, comprising registering the position of the indicators with a multi-axis robotic arm.

22. The method of claim 21, wherein the robotic arm comprises an end effector to mate with the indicator

23. The method of claim 11, comprising determining coordinates of an implant from coordinates of indicators.

24. The method of claim 11, comprising registering the impression tray while the impression tray sits on a stone model.
